(19) United States
(12) Patent Application Publication
(10) Pub. No.: US 2020/0385527 A1
(43) Pub. Date: Dec. 10, 2020

(54) MOISTURE CURABLE SILICONE POLYMER AND USES THEREOF

(71) Applicants: HENKEL IP & HOLDING GMBH, Duesseldorf (DE); HENKEL AG & CO. KGAA, Duesseldorf (DE)

(72) Inventors: Yuxia LIU, Dayton, NJ (US); Geetanjaliben Shah, Somerset, NJ (US); Therese Hemery, Wiesbaden (DE); Alfred Anthony Decato, Highland, MI (US); Abhijit Hirekerur, Troy, MI (US)

(21) Appl. No.: 16/999,999

(22) Filed: Aug. 21, 2020

Related U.S. Application Data
(63) Continuation of application No. PCT/US2019/019212, filed on Feb. 22, 2019.
(60) Provisional application No. 62/634,431, filed on Feb. 23, 2018.
(60) Provisional application No. 62/633,975, filed on Feb. 22, 2018.

(51) Int. Cl. C08G 77/04; C08K 3/36

(52) U.S. Cl. CPC C08G 77/04; C08K 3/36

(57) ABSTRACT

The present invention provides moisture curable silicone polymers and compositions thereof, having improved resistance to automotive oil and high temperature. The silicone polymers contain terminal moisture curable functional groups and a linkage that separate the siloxane backbone from the moisture curable functional groups. The linkage confers oil resistance at elevated temperatures to the cured compositions. The silicone polymers and compositions cure by way of a condensation mechanism in the presence of moisture and a catalyst. The silicone polymers and compositions are particularly useful as sealants and gaskets in automotive powertrains.

### FIELD OF THE INVENTION

The invention relates to moisture curable silicone polymers and compositions thereof with improved oil and heat resistance at elevated temperature, suitable as silicone room-temperature-vulcanizing sealants and adhesives for automotive gasketing.

### BACKGROUND OF THE INVENTION

Curable silicone polymers and compositions are used as adhesives, sealants, releasing coatings, conformal coatings, potting compounds, encapsulants, and the like, in a broad range of applications including automotive, construction, highway, electronic device and package assembly, appliance assembly and consumer uses. Typically, curable silicone polymers and compositions used in these applications have been tailored to provide the strength, toughness, cure speed, modulus, elongation, resistance to high temperatures and humidity. For instance, the curable silicone polymers and compositions can be formed into gaskets, which are used extensively in the automotive industry. In use, silicone compositions are subjected to a variety of conditions, and must continue to function without compromised integrity. One such condition includes exposure to engine oil at elevated temperatures.

Oil resistant silicone compositions as sealants are generally known. In particular, U.S. Pat. No. 4,514,529 generally discloses a low modulus, high elongation RTV (room-temperature-vulcanizing) silicone composition having oil resistance. This composition includes a silanol-terminated silicone polymer of 2,000 to 250,000 cst, a silicone fluid plasticizer terminated with triorganosiloxy groups, a cross-linking agent, a catalyst and a filler. Articles formed from such a composition can be used as, e.g., gasket sealants, as well as formed-in-place gaskets for use on internal combustion engines.

U.S. Pat. Nos. 4,673,750, 4,735,979 and 4,847,396 generally disclose adhesion promoter compositions for use in autoadhering, one-component room-temperature vulcanization (“RTV”) silicone sealant systems having oil resistance. The adhesion promoters set forth in these patents include glycidoxyalkyl substituted mixed alkoxyoxime silanes and di-substituted mixed oximealkoxysilylalkyl ureas, respectively. The RTV silicone compositions that contain these oxime adhesion promoters generally include hydroxy terminated polydimethylsiloxanes, trimethylsilyl terminated polydimethylsiloxanes and various other fillers, additives and catalysts. Such compositions are used to make formed-in-place gasket materials.

International Publication No. 9319130 discloses a one-part RTV silicone rubber composition as a formed-in-place gasket having oil resistant properties. The composition includes a silicone polymer, a plasticizer, such as a trimethyl-terminated nonreactive silicone composition, γ-aminopropyltriethoxysilane, a catalyst, a crosslinker and various fillers. One drawback to the RTV silicone compositions above is their slow rate of cure, which is commercially unacceptable for certain applications, such as sealing electronic modules, where high volume production may depend upon cure rate. Accordingly, silicone compositions with improved cure rates are desirable.

In addition, inclusion of certain grades of metal oxides to silicone compositions is known to provide a certain degree of oil resistance. For example, European Patent Publication No. 0572148 incorporates mixed metal oxides into heat curablesilicone elastomeric compositions containing MQ resins (M represents R₃SiO_{1/2} mono-functional units; Q represents SiO₂ quadri-functional units). When formed into engine gaskets they exhibit a certain degree of oil resistance. Magnesium oxide is disclosed as one component of a mixture of metal oxides from group (IIa) and (IIb). However, this reference is silent as to the benefits, if any, conveyed by the use of a single metal oxide on the oil resistance of the final elastomer.

U.S. Pat. No. 5,082,886 describes liquid injection molded (LIM) silicone compositions containing magnesium oxide to impart oil resistance to the elastomeric product. The use of magnesium oxide in the LIM system, however, adversely affects the compression set imparted by the platinum catalyst. To counteract this affect, cerium hydroxide or tetramethyldivinyldisilane must also be added; but this adds complexity to the process and increases the cost of the final product.

U.S. Pat. No. 4,052,357 describes a silicone rubber composition used as a seal or gasket. This composition includes a silicone polymer, a reinforcing silica filler, a hydroxylated silicone polymer, fiberized blast furnace slag fibers and an alkoxy silicone polymer. While the addition of magnesium oxide to this composition may impart a some oil resistance, fiberized blast furnace slag fibers step increases cost and complexity. Moreover, the presence of the fibers decreases the tear strength of the end product. Again, magnesium oxide may impart some oil resistance to various types of silicone elastomers; however, the oil resistance conveyed by the magnesium oxide in these silicone elastomers has marginal utility because the physical characteristics of the magnesium is not optimized for the desired oil resistant property. Magnesium oxide fillers are not typically included in curable silicone compositions for the purpose of conferring oil resistance to the cured elastomer.

Silicone compositions containing silicone polymers terminated with moisture curable and non-corrosive functional groups are known to those skilled in the art. U.S. Pat. No. 3,819,563 discloses RTV silicone polymers which are endcapped with enoxysilanes. U.S. Pat. No. 4,180,642 also discloses a similar composition which includes a silane bearing a guanidine group. These silicone polymers are formed without the corrosive acid.

U.S. Pat. No. 4,721,766 discloses room temperature-curable siloxane polymers which are enoxy-endcapped and contain guanidine-bearing silanes. U.S. Pat. No. 4,721,765 discloses a similar composition that also includes an amino-containing silane.

U.S. Pat. No. 5,346,940 discloses a two-part silicone composition having a silanol terminated polyorganosiloxane, at 5% by weight of a tri- or tetra-, methoxy-, or enoxy-functional silane crosslinker, water, and a condensation catalyst. One part of the composition contains water and silanol terminated silicone polymer, and the other part is free of water and contains the crosslinker component. No reactive silicone component is present in either part.

U.S. Pat. No. 5,936,032 discloses a two-component RTV silicone composition. The silicone composition may be mixed in low ratios, and is alkoxy endcapped.

U.S. Pat. Pub. No. 2003/120016 discloses a monovalent silalkylene oligosiloxane that has silicon-bonded alkoxy groups and a monovalent hydrocarbon having at least two carbon atoms that does not have aliphatic unsaturated bonds. It fully crosslinks since the siloxane polymer has only alkoxy group at one end of the polymer chain.

U.S. Pat. No. 8,168,739 discloses a polysiloxane that is a liquid substance having low viscosity, excellent curing workability, and excellent heat resistance in the cured material. The polysiloxane is obtained by hydrolysis and polycondensation of a silicon compound having three hydrolysable groups, a silicon compound having two hydrolysable groups and a silicon compound having one hydrolysable group, and is characterized by containing a hydrosilylatable carbon-carbon unsaturated group, a hydrosilyl group and an alkoxysilyl group, and having a number average molecular weight of 500 to 20,000.

U.S. Pat. Nos. 6,184,407, 6,169,156, and 5,929,187 discloses a branched siloxane-silalkylene copolymer containing a plurality of silicon-bonded hydrogen atoms or silicon bonded alkoxy groups in the molecule. The copolymer is used to improve properties, such as, mechanical strength, adhesiveness, and durability of the product.

U.S. Pat. No. 6,127,502 discloses a polyorganosiloxane comprising at least one organofunctional group per molecule having multiple hydrolyzable groups. The organofunctional group is described by formula -Zb-R4(Z-SiR2nX3-n)a, where each R2 is an independently selected monovalent hydrocarbon radical having 1 to 18 carbon atoms; each Z is independently selected from divalent hydrocarbon radicals having 2 to 18 carbon atoms or a combination of divalent hydrocarbon radicals and siloxane segments; R4 is independently selected from a silicon atom or a siloxane radical having at least two silicon atoms and each Z is bonded to a silicon atom of R4 with the remaining valences of the silicon atoms of R4 being bonded to a hydrogen atom, a monovalent hydrocarbon radical having 1 to 18 carbon atoms or forming siloxane bonds; each X is independently selected from halogen, alkoxy, acyloxy or ketoximo; n is 0, 1 or 2; a is at least 2; and b is 0 or 1, provided, when b is 0, R<4> is bonded to the polyorganosiloxane through a siloxane bond.

JP 2010-174081 discloses a method of producing a terminal hydrocarbyloxy group-containing diorganopolysiloxane having a specific structure includes mixing a reaction liquid containing (A) a diorganopolysiloxane having an alkenyl group, (B) a hydrosilyl group-containing hydrocarbyloxysilane by hydrosilylation.

U.S. Pat. No. 9,346,945 discloses filled silicone composition, in situ preparation and use thereof are provided. The composition comprises a mixture of (A) an in situ-prepared treated silica, (B) an in situ-prepared (siloxane-alkylene)-endblocked polydiorganosiloxane, (C) a cure catalyst and (D) a crosslinker. Moreover, the composition can be used as adhesive, coating and sealant.

Silicone polymers have poor oil resistance at high temperature due to well-known in the art called “end group backbiting,” “backbiting” or “unzipping” reaction. Little has been done to improve the oil resistance from the end structure modification of the silicone polymers. Accordingly, there is a need in the art for silicone polymers which undergo efficient moisture cure, form no corrosive acid by product; and at the same time have good oil resistance at elevated temperatures, avoid the use of exhausted fillers, and prevent intrinsic silicone backbone degradation by backbiting reactions. The current invention fulfills this need.

### BRIEF SUMMARY OF THE INVENTION

The invention provides moisture curable silicone polymers and compositions thereof for sealing and adhering flanges in the automotive powertrains and HVAC. In use, cured silicone compositions in the invention may be exposed to a variety of conditions including high temperature, automotive oils, acid, and should continue to function without compromised integrity. One such condition includes exposure to engine oil at elevated temperatures.

One aspect of the invention is directed to a silicone polymer having the structural of:

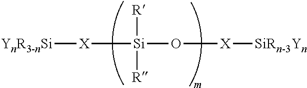

wherein,
each R, R′ and R″ are independently, alkyl, aryl, fluoroalkyl, trialkylsilyl, triarylsilyl, vinyl, H or combination thereof;
X is a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof;
Y is alkoxy, aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
m≥1;
n=1, 2, or 3; and
the weight average molecular weight (Mw) of the silicone polymer is from 100 to 1,000,000 g/mol.

Another aspect of the invention is directed to a method of making a silicone polymer comprising a reaction product of:
(a) about 10 to about 90% of a vinyl terminated polyorganosiloxane having a weight average molecular weight greater than about 100,000 g/mol, preferably greater than about 120,000 g/mol;
(b) about 1 to about 50% of a vinyl terminated polyorganosiloxane having a weight average molecular weight less than about 100,000 g/mol, preferably greater than about 70,000 g/mol;
(c) about 0.1 to about 10% of a hydride functional silane YₙR₃₋ₙSiH; and
(d) about 0.00001 to about 5% of a hydrosilylation catalyst;
   wherein,
R is alkyl, aryl, fluoroalkyl, trialkylsilyl, triarylsilyl, vinyl, H or combination thereof;
Y is alkoxy, aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
n=1, 2, or 3.

In yet another aspect of the invention is directed to a method of making a silicone polymer comprising a reaction product of:
(a) about 50 to about 90% of a vinyl terminated polyorganosiloxane having a weight average molecular weight greater than about 100,000 g/mol, preferably greater than about 120,000 g/mol;
(b) about 1 to about 50% of a vinyl terminated polyorganosiloxane having a weight average molecular weight less than about 100,000 g/mol, preferably less than about 70,000 g/mol;
(c) about 1 to about 50% of hydride terminated polyorganosiloxane a having a weight average molecular weight less than about 100,000 g/mol, preferably less than about 70,000 g/mol, most preferably less than 1,000 g/mol;
(d) about 0.1 to about 10% of a vinyl functional silane YₙR₃₋ₙSi(CH═CH2); and
(e) about 0.00001 to about 5% of a hydrosilylation catalyst;
   wherein,
R is alkyl, aryl, fluoroalkyl, trialkylsilyl, triarylsilyl, vinyl, H or combination thereof;
Y is alkoxy, aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
n=1, 2, or 3.

Another aspect of the invention is directed to a moisture curable silicone composition comprising:
(a) about 10 to about 90% of the silicone polymer having a structure of:

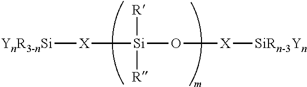

wherein,
each R, R′ and R″ are independently, alkyl, aryl, fluoroalkyl, trialkylsilyl, triarylsilyl, vinyl, H or combination thereof;
X is a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof;
Y is alkoxy, aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
m≥1;
n=1, 2, or 3; and
   the weight average molecular weight (Mw) of the silicone polymer is from 100 to 1,000,000 g/mol;
   (b) about 5 to about 90% of a finely-divided inorganic filler or a mixer of fillers;
   (c) about 0.00001 to about 5% of a moisture curing catalyst.

These and other aspects of the invention are described in the description below. In no event should the above summary be construed as a limitation on the claimed subject matter which is defined solely by the claimed as set forth herein.

### BRIEF DESCRIPTION OF THE DRAWINGS

FIG. 1 is an NMR Spectrum of Example 5.

FIG. 2 is an NMR Spectrum of Example 6.

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

As used herein, a polymer or an oligomer is a macromolecule that consists of monomer units is equal or greater than about one monomer unit. Polymer and oligomer, or polymeric and oligomeric, are used interchangeably here in the invention.

As used herein, the term “alkyl” refers to a monovalent linear, cyclic or branched moiety containing C1 to C24 carbon and only single bonds between carbon atoms in the moiety and including, for example, methyl, ethyl, propyl, isopropyl, n-butyl, sec-butyl, isobutyl, tert-butyl, n-pentyl, n-hexyl, heptyl, 2,4,4-trimethylpentyl, 2-ethylhexyl, n-octyl, n-nonyl, n-decyl, n-undecyl, n-dodecyl, n-hexadecyl, and n-octadecyl.

As used herein, the term “aryl” refers to a monovalent unsaturated aromatic carbocyclic group of from 6 to 24 carbon atoms having a single ring (e.g., phenyl) or multiple condensed (fused) rings, wherein at least one ring is aromatic (e.g., naphthyl, dihydrophenanthrenyl, fluorenyl, or anthryl). Preferred examples include phenyl, methyl phenyl, ethyl phenyl, methyl naphthyl, ethyl naphthyl, and the like.

As used herein, the term “alkoxy” refers to the group —O—R, wherein R is alkyl as defined above.

As used herein, the above groups may be further substituted or unsubstituted. When substituted, hydrogen atoms on the groups are replaced by substituent group(s) that is one or more groups independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof. In case that an aryl is substituted, substituents on an aryl group may form a non-aromatic ring fused to the aryl group, including a cycloalkyl, cycloalkenyl, cycloalkynyl, and heterocyclyl.

The term, “moisture cure” herein refers to hardening or vulcanization of the curable portion of the material or polymer by condensation crosslinking reaction of terminal functional group of polymer chains, brought about by water or moisture in the air, in the presence of a moisture curing catalyst.

The term, “silicone polymers” herein refers to siloxane polymers, polydiorganosiloxanes or polydiorganosiloxanes, such as polydimethylsiloxane (PDMS).

The invention provides the art with a novel class of silicone polymers with terminal group that can undergo moisture cure and at the same time resist the back-bite. In particular, the polymers demonstrate improved oil resistance at 150° C. for over 1000 hr.

Silanol and/or alkoxysilyl terminated silicone polymers undergo moisture cure in the air in the presence of a moisture curing catalyst. They are widely used as in-sealants and adhesives. However, the silanol or alkoxy terminated silicone polymers easily undergo degradation and depolymerization in oil at high temperature through a “unzipping” or “chain back bite” mechanism, as reported in Polymer Degradation and Stability 94 (2009) 465-495. When a silanol and/or alkoxysilyl terminated silicone polymer is heated, its viscosimetric molecular weight first sharply increases, which is typical of an intermolecular reaction between the polymer chain ends through silanol condensation reactions. Prolonged high temperature condition leads to decreased polymer molecular weight due to silanol functions that ‘back-bite′ to promote intramolecular redistribution reactions, and this generates low molecular weight cyclic siloxanes. The degradation process is usually worsened in the presence of acid or base that is typically present in aged oil. Volatile cyclic trimer and tetramer are the most prominent products of this fragmentation and depolymerization because of their kinetic and thermodynamic stability at the degradation temperatures. Their evaporation adds an additional driving force for the degradation process. The decrease in molar mass is found to be linear with the extent of volatilization, confirming the stepwise nature of the formation of volatiles characteristic of the unzipping reaction. Thus, the depolymerization of PDMS is governed mainly by the molecular structure and kinetic considerations, and not by bond energies. The formation of an intramolecular, cyclic transition state is the rate-determining step. While not bound to a specific theory, silicon d-orbital participation is postulated with siloxane bond rearrangement leading to the elimination of cyclic oligomers and shortening of the chain.

The carbon-carbon (C—C) spacers between the polysiloxane backbone and the moisture cure moiety prevents silicone polymer degradation of the back-bite mechanism through their relatively stiffness. Moreover, the C—C spacers affect the thermal stability of the silicone polymer. Useful stiff spacers in the silicone polymers include a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof. Useful moisture cure moiety in the silicone polymer include, well known to those in the art, usually silyl group containing substituent group of alkoxy, aryloxy, acetoxy, oximino, enoxy, amino, lactate amido, lactate ester, H, or halogen.

One aspect of the invention is directed to a silicone polymer with the structural formula:

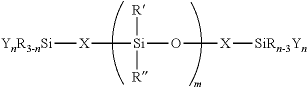

wherein,
each R, R′ and R″ are independently, alkyl, aryl, fluoroalkyl, trialkylsilyl, triarylsilyl, vinyl, or combination thereof;
X is a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof;
Y is alkoxy, aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
m≥1;
n=1, 2, or 3;
the weight average molecular weight (Mw) of the silicone polymer is from 100 to 1,000,000 g/mol.

In one embodiment, the above silicone polymer structure has:
each R, R′ and R″ are independently, methyl, phenyl, trifluoropropyl, vinyl, H or combination thereof;
X is the stiff spacers, which is a linear link having a divalent alkylene, siloxane-alkylene, siloxane-arylene, or a derivative or combination thereof;
Y is alkoxy, oximino, enoxy, α-hydroxycarboxylic acid amide (—OCR′₂CONR″₂), α-hydroxycarboxylic acid ester (—OCR′₂COOR″), or combination thereof;
m≥1;
n=2, or 3.

In one preferred embodiment, the silicone polymer has the following structural formula:

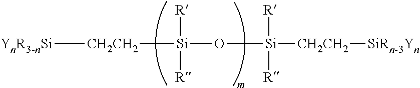

In another preferred embodiment, the silicone polymer has the following structural formula:

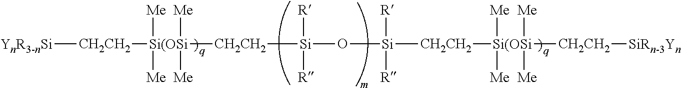

where q≥1.

Yet in another preferred embodiment, the silicone polymer has the following structural formula:

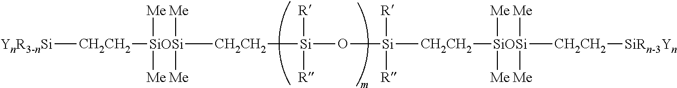

Another aspect of the invention is directed to a method of making the silicone polymers. The components to form the silicone polymers comprise vinyl terminated siloxane polymers, hydride terminated siloxane polymers, silanes having a structure of vinylSiYₙSiR₃₋ₙ, HSiYₙSiR₃₋ₙ (as defined above) or a combination thereof, and a hydrosilylation catalyst.

The vinyl terminated or hydride terminated siloxane polymers are polyorganosiloxane polymers having α,ω-endcapped vinyl or H groups. The polyorganosiloxane polymers have at least two or more (R′R″SiO) unit, wherein R′ and R″ are independently alkyl, aryl, fluoroalkyl, trialkylsilyl, triarylsilyl, vinyl, or combination thereof. Examples of polyorganosiloxane polymers are polydialkylsiloxane, polydiarylsiloxane, polyalkylarylsiloxane. In a preferred embodiment, polyorganosiloxane polymers are polymers or copolymers of polydimethylsiloxane, polydiphenylsiloxane, polymethylphenylsiloxane, poly(3,3,3-trifluoropropylmethyl)siloxane, or a mixture thereof. In a most preferred embodiment, the polyorganosiloxane polymers are vinyl terminated polydimethylsiloxanes (PDMS).

In one embodiment of the invention of making the silicone polymers, two vinyl terminated siloxane polymers and one hydride terminated siloxane polymer are used to form the silicone polymer product. The first vinyl terminated siloxane polymer is a high molecular weight siloxane polymer with the weight average molecular weight (Mw) above 100,000 g/mol, preferably, from about 120,000 to about 1,000,000 g/mol. The high molecular weight siloxane polymer will provide cohesive strength, adhesion and elongation. The second vinyl terminated siloxane polymer is a low molecular weight polymer with the weight average molecular weight (Mw) below 100,000 g/mol, preferably from about 5,000 to about 70,000 g/mol. The second vinyl terminated siloxane polymer will provide adjustable crosslinking density and viscosity of the adhesive. High and low molecular weight reactive siloxane polymers are used together to regulate the crosslinking density, modulus and viscosity of the silicone polymers and compositions. The hydride terminated siloxane polymer has a weight average molecular weight less than about 100,000 g/mol, preferably less than about 70,000 g/mol, more preferably less than 1,000 g/mol.

In another embodiment of the invention of making the silicone polymers, two hydride terminated siloxane polymers and one vinyl terminated siloxane polymer are used to form the silicone polymer product. The first hydride terminated siloxane polymer is a high molecular weight siloxane polymer with the weight average molecular weight (Mw) above 100,000 g/mol, preferably, from about 120,000 to about 1,000,000 g/mol. The high molecular weight siloxane polymer will provide high cohesive strength, peel adhesion and elongation. The second hydride terminated siloxane polymer is a low molecular weight polymer with the weight average molecular weight (Mw) below 100,000 g/mol, preferably from about 5,000 to about 70,000 g/mol. The second hydride terminated siloxane polymer will provide adjustable crosslinking density and viscosity of the adhesive. High and low molecular weight reactive siloxane polymers are used together to regulate the crosslinking density, modulus and viscosity of the silicone polymers and compositions. The vinyl terminated siloxane polymer has a weight average molecular weight less than about 100,000 g/mol, preferably less than about 70,000 g/mol, most preferably less than 1,000 g/mol.

The silanes used to make the silicone polymers have the structure of vinyl-SiYₙSiR₃₋ₙ, wherein the R is independently, alkyl, aryl, fluoroalkyl, trialkylsilyl, triarylsilyl, or a combination thereof; Y is alkoxy, aryloxy, acetoxy, oximino, enoxy, amino, amido, ester, halogen, n is 1 to 3. Examples of the vinyl-SiYₙSiR₃₋ₙ silanes are vinyltrimethoxysilane, vinylmethydimethoxysilane, vinyldimethylmethoxysilane, vinyltriethoxysilane, and the like. The vinyl-SiYₙSiR₃₋ₙ will typically be used in amounts of from 0.01 to 30 weight percent, more preferably, 0.1 to 20 weight percent of the silicone polymers.

The silanes used to make the silicone polymers have the structure of HSiYₙSiR₃₋ₙ, wherein the R is independently, alkyl, aryl, fluoroalkyl, trialkylsilyl, triarylsilyl, or a combination thereof; Y is alkoxy, aryloxy, acetoxy, oximino, enoxy, lactate amide, lactate ester, halogen, n is 1 to 3. Examples of HSiYₙSiR₃₋ₙ silanes are hydrogentrimethoxysilane, hydrogenmethydimethoxysilane, hydrogendimethylmethoxysilane, hydrogentriethoxysilane, and the like. The HSiYₙSiR₃₋ₙ silanes will typically be used in amounts of from 0.01 to 30 weight percent, more preferably, 0.1 to 20 weight percent of the silicone polymers.

The silicone polymer products are typically formed in neat and in the presence of an appropriate hydrosilylation catalyst. No organic solvent is needed

The hydrosilylation catalyst in the invention is a transition metal complex of Pt, Rh, Ru. The preferred catalyst is Speier's catalyst H₂PtCl₆, or Karstedt's catalyst, or any alkene-stabilized platinum(0). The utility of non-transition metal catalysts including early main group metals, borane and phosphonium salts as well as N-heterocyclic carbenes has also been disclosed.

Yet another aspect of the invention is directed to the method of using the silicone polymers to make silicone adhesives and sealants. The silicone adhesive or sealant composition comprises the silicone polymers in the invention, fillers and a moisture curing catalyst which initiates the moisture curing of the compositions in the presence of moisture. The crosslinking reaction is a condensation reaction and leads to a product of crosslinked network through Si—O—Si covenant bond among the moisture reactive components.

The fillers useful in the present invention are finely-divided inorganic fillers. By “finely-divided” it is meant that the average particle size of the filler is less than about 5 microns. Advantageously, the inorganic fillers have an average particle diameter from about 0.2 to about 2.0 microns. In a particularly advantageous embodiment: i) at least about 90% of the inorganic fillers have a diameter less than 2 microns; and ii) at least about 65% of the inorganic fillers have a diameter less than 1 micron. The fillers may be present in an amount of at least about 15% by weight of the total composition. Desirably the fillers are present in an amount from about 25% to about 80%, and more desirably from about from about 25% to about 60%, by weight of the total composition.

The silicone compositions of the present invention include certain fillers to assist in conferring oil resistance properties to the final cured compositions. The fillers are basic in nature so that they are available to react with any acidic by-products formed in the working environment in which the inventive compositions are intended to be used. By so doing, the fillers neutralize acidic by-products before such by-products degrade the elastomers, thereby improving adhesion retention. These fillers include, for example, lithopone, zirconium silicate, diatomaceous earth, calcium clay, hydroxides, such as hydroxides of calcium, aluminum, magnesium, iron and the like, carbonates, such as carbonates of sodium, potassium, calcium, and magnesium carbonates, metal oxides, such as metal oxides of zinc, magnesium, chromic, zirconium, aluminum, titanium and ferric oxide; and mixtures thereof. The fillers may be present in the composition in any suitable concentration in the curable compositions.

A preferred filler is calcium carbonate. A commercially available example of a calcium carbonate filler suitable for use in the present invention is sold by Omya, Inc. under the tradename OMYACARB® UF-FL. Any commercially available precipitated calcium carbonate can be used with the present invention. The precipitated calcium carbonate should be present, for example, in an amount from about 5 to about 50% by weight of the total composition. Desirably, the calcium carbonate is present in an amount from about 5 to about 15% by weight.

Together with the precipitated calcium carbonate, the present compositions may also desirably include in the basic filler component magnesium oxide particles. Desirably, the magnesium oxide is present in an amount between about 5 to about 50% by weight of the total composition, such as, for example, from about 10 to about 25% by weight. Any magnesium oxide meeting the above-described physical characteristics may be used in accordance with the present invention. Desirably, the magnesium oxide of the present invention is MAGCHEM 50M and MAGCHEM 200-AD, commercially available from Martin Marietta Magnesia Specialties, Inc., Baltimore, Md. These commercially available fillers contain about 90% by weight or more magnesium oxide particles with a variety of other oxides including, for example, calcium oxide, silicon dioxide, iron oxide, aluminum oxide and sulfur trioxide.

Another type of desirable fillers is reinforcing silica. The silica may be a fumed silica, which may be untreated or treated with an adjuvant so as to render it hydrophobic. The fumed silica should be present at a level of at least about 5% by weight of the composition in order to obtain any substantial reinforcing effect. Although optimal silica level varies depending on the characteristics of the particular silica, it has generally been observed that the thixotropic effect of the silica produces compositions of impractically high viscosity before maximum reinforcing effect is reached. Hydrophobic silica tends to display lower thixotropic effect, and therefore greater amounts can be included in a composition of desired consistency. In choosing the silica level, therefore, desired reinforcement and practical viscosity must be balanced. A hexamethydisilazane treated fumed silica is particularly desirable (HDK2000 by Wacker-Chemie, Burghausen, Germany). A commercially available example of a fumed silica suitable for use in the present invention is sold by Degussa under the trade name AEROSIL R 8200.

To modify the dispensing properties of the compositions through viscosity adjustment, a thixotropic agent may be desirable. The thixotropic agent is used in an amount within the range of about 0.05 to about 25% by weight of the total composition. As mentioned before, a common example of such a thixotropic agent includes fumed silicas, and may be untreated or treated so as to alter the chemical nature of their surface. Virtually any reinforcing fumed silica may be used. Examples of such treated fumed silica include polydimethylsiloxane-treated silica and hexamethyldisilazane-treated silica. Such treated silicas are commercially available, such as from Cabot Corporation under the tradename CABSIL ND-TS and Evonik AEROSIL, such as AEROSIL R805. Of the untreated silicas, amorphous and hydrous silicas may be used. For instance, commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm; and commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.). Other desirable fillers for use as the thixotropic agent include those constructed of or containing aluminum oxide, silicon nitride, aluminum nitride and silica-coated aluminum nitride. Hydroxyl-functional alcohols are also well-suited as the thixotropic agent, such as tris[copoly(oxypropylene) (oxypropylene)]ether of trimethylol propane, and polyalkylene gycol available commercially from BASF under the tradename PLURACOL V-10.

Other conventional fillers can also be incorporated into the present compositions provided they impart basicity to the compositions, and do not adversely affect the oil resistant curing mechanism and adhesive properties of the final produced therefrom. Generally, any suitable mineral, carbonaceous, glass, or ceramic filler maybe used, including, but not limited to: precipitated silica; clay; metal salts of sulfates; chalk, lime powder; precipitated and/or pyrogenic silicic acid; phosphates; carbon black; quartz; zirconium silicate; gypsum; silicium nitride; boron nitride; zeolite; glass; plastic powder; graphite; synthetic fibers and mixtures thereof. The filler may be used in an amount within the range of about 5 to 70% by weight of the total composition. A commercially available example of a precipitated silica filler suitable for use in the present is sold by the J.M. Huber under the trade name ZEOTHIX 95.

Organic fillers can also be used, particularly silicone resins, wood fibers, wood flour, sawdust, cellulose, cotton, pulp, cotton, wood chips, chopped straw, and chaff. Further, short fibers such as glass fibers, glass filament, polyacrylonitrile, carbon fibers, Kevlar fibers, or polyethylene fibers as well can also be added.

The moisture curing catalyst used in the moisture curable silicone compositions in the invention includes those known to the person skilled in the art to be useful for catalyzing and facilitating moisture curing. The catalyst can be metal and non-metal catalysts. Examples of metal catalysts useful in the present invention include tin, titanium, zinc, zirconium, lead, iron cobalt, antimony, manganese and bismuth organometallic compounds. Examples of non-metal based catalysts include amines, amidines, and guanidines.

In one embodiment, the moisture curing catalyst useful for facilitating the moisture curing of the silicone compositions is selected from but is not limited to dibutyltin dilaurate, dimethyldineodecanoatetin, dioctyltin didecylmercaptide, bis(neodecanoyloxy)dioctylstannane, dimethylbis(oleoyloxy)stannane, dibutyltindiacetate, dibutyltindimethoxide, tinoctoate, isobutyltintriceroate, dibutyltinoxide, solubilized dibutyl tin oxide, dibutyltin bisdiisooctylphthalate, bis-tripropoxysilyl dioctyltin, dibutyltin bis-acetylacetone, silylated dibutyltin dioxide, carbomethoxyphenyl tin tris-uberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, tinbutyrate, d-ioctyltin d-idecylm ercaptide, bis(neodecanoyloxy)d-ioctylstannane, or dimethylbis(oleoyloxy)stannane. In one preferred embodiment, the moisture curing catalyst is selected from a group of dimethyldineodecanoatetin (available from Momentive Performance Materials Inc. under the trade name of FOMREZ UL-28, dioctyltin didecylmercaptide (available from Momentive Performance Materials Inc. under the trade name of FOMREZ UL-32), bis(neodecanoyloxy)dioctylstannane (available from Momentive Performance Materials Inc. under the trade name of FOMREZ UL-38), dimethylbis(oleoyloxy)stannane (available from Momentive Performance Materials Inc. under the trade name of FOMREZ UL-50), and combination thereof. More preferably, the moisture curing catalyst is dimethyldineodecanoatetin. In the moisture compositions according to the present invention, the moisture curing catalyst is present in an amount from 0.1 to 5% by weight, based on the total weight of the compositions.

Environmental regulatory agencies and directives, however, have increased or are expected to increase restrictions on the use of organotin compounds in formulated products. For example, compositions with greater than 0.5 wt. % dibutyltin presently require labeling as toxic with reproductive IB classification. Dibutyltin containing compositions are proposed to be completely phased out in consumer applications during the next three to five years. The use of alternative organotin compounds such as dioctyltin compounds and dimethyltin compounds can only be considered as a short-term remedial plan, as these organotin compounds may also be regulated in the future. It would be beneficial to identify non-tin-based compounds that accelerate the condensation curing of moisture-curable silicone compositions. Examples of non-toxic substitutes for organotin catalysts include titanium isopropoxide, zirconium octanoate, iron octanoate, zinc octanoate, cobalt naphthenate, tetrapropyltitanate, tetrabutyltitanate, and the like. Other non-toxic substitutes for organotin catalysts are based on amino acid compounds. Examples of amino acid catalysts where the amino acid compound is an N-substituted amino acid comprising at least one group other than hydrogen attached to the N-terminus. In another embodiment, the present invention may include curable compositions employing an amino acid compound as a condensation accelerator where the amino acid compound is an O-substituted amino acid comprising a group other than hydrogen attached to the 0-terminus. Other suitable amine catalysts include, for example, amino-functional silanes. The non-toxic moisture cure catalyst is employed in an amount sufficient to effectuate moisture-cure, which generally is from about 0.05% to about 5.00% by weight, and advantageously from about 0.5% to about 2.5% by weight.

The silicone compositions can further comprise, optionally, silane adhesion promotors, functional polymeric and/or oligomeric adhesion promoters. An adhesion promoter may act to enhance the adhesive character of the curable silicone composition for a specific substrate (i.e., metal, glass, plastics, ceramic, and blends thereof). Any suitable adhesion promoter may be employed for such purpose, depending on the specific substrate elements employed in a given application. Examples of silane adhesion promoters that are useful include, but are not limited to, C3-C24 alkyl trialkoxysilane, (meth)acryloxypropyl trialkoxysilane, chloropropylmethoxysilane, vinyltrimethoxysilane, vinyltriethoxysilane, vinyltrismethoxyethoxysilane, vinylbenzylpropylthmethoxysilane, aminopropyltrimethoxysilane, vinylthacetoxysilane, glycidoxypropyltrialkoxysilane, beta.-(3,4-epoxycyclohexyl)ethyltrimethoxysilane, mercaptopropylmethoxysilane, 3-aminopropyltriethoxysilane, aminomethyltrimethoxysilane, aminomethyltriethoxysilane, 3-aminopropylmethyldiethoxysilane, (N-2-aminoethyl)-3-aminopropyltrimethoxysilane, (N-2-aminoethyl)-3-aminopropyltriethoxysilane, diethylenetriaminopropyltrimethoxysilane, phenylaminomethyltrimethoxysilane, (N-2-aminoethyl)-3-aminopropylmethyldimethoxysilane, 3-(N-phenylamino) propyltrimethoxysilane, 3-piperazinylpropylmethyldimethoxysilane, 3-(N,N-dimethylaminopropyl) aminopropylmethyldimethoxysilane, tri[(3-triethoxysilyl)propyl]amine, tri[(3-trimethoxysilyl)propyl]amine, 3-(N,N-dimethylamino)propyltrimethoxysilane, 3-(N,N-dimethylamino)-propyltriethoxysilane, (N,N-dimethylamino)methyltrimethoxysilane, (N,N-dimethylamino)methyltriethoxysilane, bis(3-trimethoxysilyl)propylamine, bis(3-triethoxysilyl)propylamin, and mixtures thereof, particularly preferably of 3-aminopropyltrimethoxysilane, 3-aminopropyltriethoxysilane, aminomethyltrimethoxysilane, aminomethyltriethoxysilane, 3-(N,N-dimethylamino)propyltrimethoxysilane, 3-(N,N-dimethylamino)propyltriethoxysilane, (N,N-dimethylamino)methyltrimethoxysilane, (N,N-dimethylamino)methyltriethoxysilane, bis(3-trimethoxysilyl)propylamine, bis(3-triethoxysilyl)propylamine, and mixtures thereof.

Examples of functional polymeric and/or oligomeric adhesion promoters that are useful include, but are not limited to, hydrolysable PDMS polymer or oligomer, e.g., PDMS that is endcapped with trialkoxylsilyl (meth)acrylates, dialkoxysilyl (meth)acrylates or methacrylates groups.

The adhesion promoter will typically be used in amounts of from 0.2 to 40 weight percent, more preferably, 1 to 20 weight percent of the whole curable silicone compositions.

The silicone compositions optionally include drying agents or moisture scavengers. Example of suitable drying agents are vinylsilanes such as 3-vinylpropyltriethoxysilane, oxime silanes such as methyl-O,O′,O″-butan-2-onetrioximosilane or O,O′,O″,O′″-butan-2-one-tetraoximosilane or benzamidosilanes such as bis(N-methylbenzamido)methylethoxysilane or carbamatosilanes such as carbamatomethyltrimethoxysilane. The use of methyl-, ethyl-, or vinyl-trimethoxysilane, tetramethyl- or tetraethyl-ethoxysilane is also possible, however. Vinyltrimethoxysilane and tetraethoxysilane are particularly preferred in terms of cost and efficiency. The compositions generally contain about 0 to about 6% by weight.

In the present compositions, effective amount of plasticizers may be added to ensure the desired workability of uncured compositions and performance of the final cured compositions. Both silicone and organic plasticizers can be used with the present invention.

Suitable plasticizers include, for example, trimethyl-terminated polyorganosiloxanes, petroleum derived organic oils, polybutenes, alkyl phosphates, polyalkylene glycol, poly(propylene oxides), hydroxyethylated alkyl phenol, dialkyldithiophosphonate, poly(isobutylenes), poly(α-olefins) and mixtures thereof. The plasticizer component may provide further oil resistance to the cured elastomer. Accordingly, from about 1 to about 50%, preferably from about 10 to about 35% by weight of a selected plasticizer can be incorporated into the compositions of the present invention.

The present silicone compositions may also include one or more crosslinkers. The crosslinkers may be a hexafunctional silane, though other crosslinkers may also be used. Examples of such crosslinkers include, for example, methyltrimethoxysilane, vinyltrimethoxysilane, methyltriethoxysilane, vinyltriethoxysilane, methyltriacetoxysilane, vinyltriacetoxysilane, methyl tris(N-methylbenzamido)silane, methyl tris-(isopropenoxy)silane, methyl tris-(cyclohexylamino)silane, methyl tris(methyl ethyl ketoximino)silane, vinyl tris-(methyl ethyl ketoximino)silane, methyl tris-(methyl isobutyl ketoximino)silane, vinyl tris-(methyl isobutyl ketoximino)silane, tetrakis-(methyl ethyl ketoximino)silane, tetrakis-(methylisobutyl ketoximino)silane, tetrakis-(methyl amyl ketoximino)silane, dimethyl bis-(methyl ethylketoximino)silane, methyl vinyl bis-(methyl ethyl ketoximino)silane,methyl vinyl bis-(methyl isobutyl ketoximino)silane, methylvinyl bis-(methyl amyl ketoximino)silane, tetrafunctionalalkoxy-ketoxime silane, tetrafunctional alkoxy-ketoximinosilane, tris- or tetrakis-enoxysilane, tris- or tetrakis-lactate amidosilane and tris- or tetrakis-lactate estersilane.

Typically, the crosslinkers used in of the present compositions are present from about 1 to about 10% by weight of the total composition. The exact concentration of the crosslinker; however, may vary according to the specific reagents, the desired cure rate, molecular weight of the silicone polymers used in the compositions.

The present silicone compositions may also contain other additives so long as they do not inhibit the curing mechanism or intended use. For example, conventional additives such as pigments, inhibitors, odor masks, and the like may be included.

Reaction products of the present silicone polymers and compositions are useful as adhesives or sealants for bonding, sealing, encapsulating metal surfaces that are exposed to oil during their intended use. The silicone compositions of the present invention may also be formed into many different configurations and then addition-cured. Articles formed in such a manner are useful in various industries where there is a need for oil resistant silicone based elastomeric articles. In vehicular assembly industry, for example, O-rings, hoses, seals, and gaskets can be formed from the present compositions. Other conventional uses requiring good sealing properties, as well as oil resistance are also contemplated for the inventive compositions.

In one aspect of the present invention, there is provided a method of applying the curable silicone composition to a surface exposed to oil during its intended use. The surface to which the present compositions are applied to can be any surface that is exposed to oil, such as work surfaces of conventional internal combustion engines. This method includes applying a composition of the present invention to a work surface. The work surface may be constructed of a variety of materials, such as most metals, glass, and commodity or engineered plastics. In yet another aspect of the present invention, there is provided a method of using an oil resistant mechanical seal, which remains sealed after exposure to oil. This method includes applying a seal forming amount of the composition as described previously onto a surface of a mechanical part. A seal is then formed between at least two mechanical surfaces by addition-cure through exposure to elevated temperature conditions, e.g., 150° C., after which the seal remains competent even when exposed to oil at extreme temperature conditions over extended periods of time, e.g., greater than 500 hours.

In still yet another aspect of the present invention, there is provided a method of using an oil resistant sealing member that remains adhesive after contact with and/or immersion in oil. This method includes forming a seal between two or more surfaces by applying therebetween the oil resistant sealing member formed from a composition according to the present invention. With respect to the second embodiment of the present invention, there is provided a method of improving oil resistance in such a silicone sealant composition. This method includes the steps of (a) providing the silicone sealant, (b) incorporating into the sealant at least about 5% by weight of a composition that includes magnesium oxide particles having a mean particle size of about 0.5 uM to about 1.5 tM and a mean surface area of about 50 M2/g to about 175 M2/g and (c) crosslinking the silicone sealant to form an oil resistant elastomeric article. Desirably, this sealant composition includes from about 10 to about 90% by weight of a silicone polymer, from about 1 to about 20% by weight of fumed silica, from about 5 to about 50% by weight of a precipitated calcium carbonate and/or magnesium oxide, from about 1 to about 10% by weight of a crosslinker and from about 0.05 to about 5% by weight of a moisture cure catalyst, each of which is by weight of the total composition. The sealant composition can also include other optional components including for example, plasticizers, adhesion promoters, pigments and the like.

The preparation of the moisture curable composition can take place by mixing the silicone polymer in the invention, fillers, moisture cure catalyst, and optionally the other ingredients. This mixing process can take place in suitable dispersing units, e.g., a high-speed mixer, planetary mixer and Brabender mixer, In all cases, care is taken that the mixture does not come into contact with moisture, which could lead to an undesirable curing. Suitable measures are sufficiently known in the art: mixing in an inert atmosphere under a protective gas, and drying/heating individual components before addition.

### EXAMPLES

Hydroxy terminated PDMS, vinyl terminated PDMS, hydride terminated PDMS, Karstedt's catalyst Pt(0), aminopropyltrimethoxysilane, vinylmethyldimethoxysilane, vinyltrimethoxysilane, tetramethyldisiloxane, trichlorosilane, trimethoxysilane, methyldimethoxysilane are available from Gelest, Inc.

KOH (1.0M), Chloroplatinic acid (H₂PtCl₆) and hexamethyldisilazane are available from Sigma-Aldrich.

SF105F engine oil is available from Test Monitoring Center.

Skin-Over Time Measurement:

The skin-over time was determined under standard climatic conditions (25+/−2° C., relative humidity 50+/−5%). The compositions were applied to a sheet of paper and drawn out to a skin with a putty knife (thickness of about 2 mm, width of about 7 cm). A stopwatch was started immediately. The surface was touched lightly with the fingertip until the composition no longer adheres to the fingertip. The skin-over time is recorded in hours.

Shore OO Hardness:

The procedure followed ASTM D2240-00, using Shore Durometer.

Mechanical Properties (Tensile Test):

The elongation at break, and tensile stress values (E modulus) were determined in accordance with DIN 53504 using the tensile test. Sample dumbbell specimens with the following dimensions were used as the test pieces: thickness: 2+/−0.2 mm; gauge width: 10+/−0.5 mm; gauge length: about 45 mm; total length: 9 cm. The test took place after seven days of curing. A two mm-thick film was drawn out of the material. The film was stored for seven days under standard climatic conditions, and the dumbbells were then punched out. Three dumbbells were made for each test. The test was carried out under standard climatic conditions (23+/−2° C., 50+/−5% rel. humidity). The specimens were acclimatized to the test temperature (i.e., stored) for at least 20 minutes before the measurement. Before the measurement, the thickness of the test specimens was measured at three places at room temperature using a vernier caliper; i.e., for the dumbbells, at the ends, and the middle within the initial gauge length. The average values were entered in the measuring program. The test specimens were clamped in the tensile testing machine so that the longitudinal axis coincided with the mechanical axis of the tensile testing machine and the largest possible surface of the grips was grasped, without the narrow section being clamped. At a test speed of 50 mm/min, the dumbbell tensioned to a preload of <0.1 MPa.

### Comparative Example 1. Preparation of Silane Modified Silicone Polymer (I)

A solution of PDMS (Mw 140K, PDI 1.8) (37 g) and PMDS (Mw 55K, PDI 1.6) (7.9 g) in heptane (60 mL) was stirred at reflux for 1 hour under nitrogen gas. Vinyltrimethoxysilane (0.1 g), and aminopropyltrimethoxysilane (0.12 g) and nBuLi were added and the mixture was stirred at reflux for 3 hr. Additional vinyltrimethoxysilane (0.35 g) was added and mixed at reflux for 3 hr under nitrogen gas. Nitrogen gas was turned off and CO₂ gas was introduced subsurface for 1 h. Hexamethyldisilazane was added and mixed for 1 hr. The solvent was then removed under vacuum at 60° C. and the product was collected as a colorless viscous liquid in a quantitative yield. The identity of this compound was confirmed by ¹H, ¹³C and ²⁹Si NMR to have the following structure (I), wherein R′ and R″ are either vinyl or aminopropyl groups.

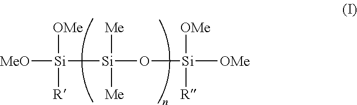

### Example 2. Preparation of Silicone Polymer (II)

A solution of PDMS (Mw 140K, PDI 1.8) (36 g, 0.31 mmol), PDMS (Mw 55K, PDI 1.6) (9 g, 0.21 mmol) and H₂PtCl₆ (20 PPM) in heptane (50 mL) was stirred at room temperature for 30 min. Trimethoxysilane (0.2 g, 1.64 mmol) was added and mixed for 1 hr. The mixture was heated to 60° C. and continued to mix for 3 hr. The solvent was then removed under vacuum at 60° C. and the product was collected as a colorless viscous liquid with a quantitative yield. The identity of this compound was confirmed by ¹H, ¹³C and ²⁹Si NMR to have the following structure (II).

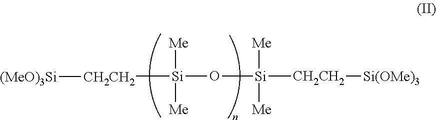

### Example 3. Preparation of Silicone Polymer (III)

A solution of PDMS (Mw 140K, PDI 1.8) (36 g, 0.31 mmol), PDMS (Mw 55K, PDI 1.6) (9 g, 0.21 mmol) and H₂PtCl₆ (20 PPM) in heptane (50 mL) was stirred at room temperature for 30 min. Dimethoxymethylsilane (0.2 g, 1.8 mmol) was added and mixed for 1 hr. The mixture was heated to 60° C. and continued to mix for 3 hr. The solvent was then removed under vacuum at 60° C. and the product was collected as a colorless viscous liquid with a quantitative yield. The identity of this compound was confirmed by ¹H, ¹³C and ²⁹Si NMR to have the following structure (Ill).

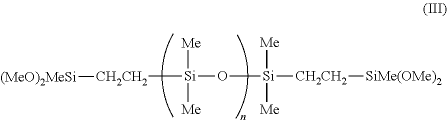

### Example 4. Preparation of Silicone Polymer (IV)

A solution of PDMS (Mw 140K, PDI 1.8) (37 g, 0.32 mmol), PDMS (Mw 55K, PDI 1.6) (8 g, 0.19 mmol) and H₂PtCl₆ (20 PPM) in heptane (50 mL) was stirred at room temperature for 1 h under nitrogen gas. Trichlorosilane (0.2 g, 1.5 mmol) was added and mixed for 1 h under nitrogen gas. The mixture was heated to 60° C. and continued to mix for 3 hr. The mixture was cool to 0° C. and NaHCO₃ (5 g) and MeOH (20 mL) were added and mixed for 1 hr. The mixture was filtered and the solvent was then removed under vacuum at 60° C. and the product was collected as a colorless viscous liquid with a quantitative yield. The identity of this compound was confirmed by ¹H, ¹³C and ²⁹Si NMR to have the following structure (IV).

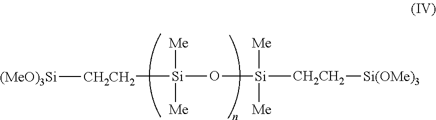

### Example 5. Preparation of Silicone Polymer (V)

A mixture of PDMS (Mw 140K, PDI 1.8) (77.7 g, 0.7 mmol), PMS (Mw 55K, PDI 1.6) (19.4 g, 0.05 mmol) and Pt(0) (200 PPM) was stirred at room temperature for 30 min. Tetramethyldisiloxane (2.2 g, 16.4 mmol) was added and mixed for 1 hr. The mixture was heated to 60° C. and continued to mix for 3 hr. The excess of tetramethyldisiloxane was removed under vacuum at 60° C. VTMO (0.7 g, 4.7 mmol) was added and the mixture was stirred at 60° C. for 4 hr. The product was collected as a colorless viscous liquid with a quantitative yield. The identity of this compound was confirmed by ¹H, ¹³C and ²⁹Si NMR to have the following structure (V), as shown in

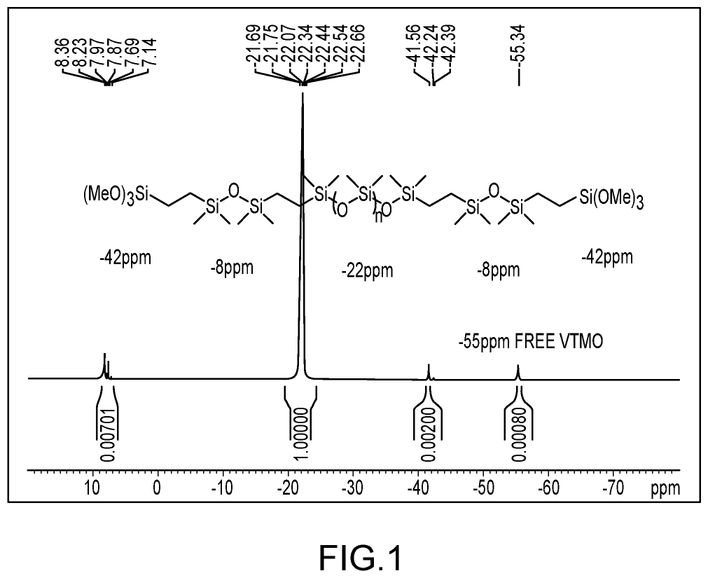

FIG. 1.

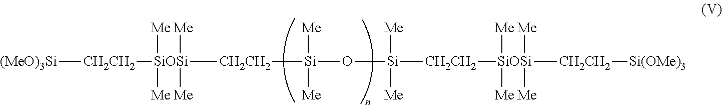

### Example 6. Preparation of Silicone Polymer (VI)

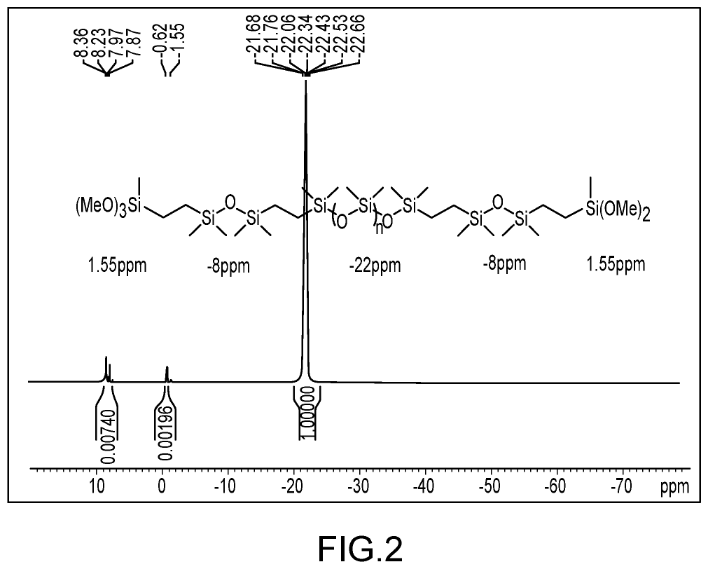

A mixture of PDMS (Mw 140K, PDI 1.8) (77.7 g, 0.7 mmol), PDMS (Mw 55K, PDI 1.6) (19.4 g, 0.05 mmol) and Pt(0) (200 PPM) was stirred at room temperature for 30 min. Tetramethyldisiloxane (2.2 g, 16.4 mmol) was added and mixed for 1 hr. The mixture was heated to 60° C. and continued to mix for 3 hr. The excess of tetramethyldisiloxane was removed under vacuum at 60° C. ViSiMe(OMe)2 (0.6 g, 4.5 mmol) was added and the mixture was stirred at 60° C. for 4 hr. The product was collected as a colorless viscous liquid with a quantitative yield. The identity of this compound was confirmed by ¹H, ¹³O and ²⁹Si NMR to have the following structure (VI), as shown in FIG. 2.

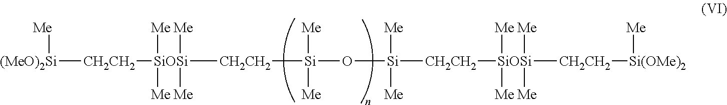

### Example 7. GPC Results of the Silicone Polymers

TABLE 1

| Examples | 1(C) | 2 | 3 | 4 | 5 | 6 |
|---|---|---|---|---|---|---|
| Polymers | I | II | III | IV | V | VI |
| Mw, g/mol | 135,000 | 117,000 | 115,000 | 120,000 | 129,000 | 130,000 |
| PDI | 7.6 | 2.8 | 2.6 | 2.8 | 2.1 | 2.4 |

All the polymers in the Examples have similar weight average molecular weights, as showed in Table 1. The comparative Example 1(C) showed higher molecular weight distribution (PDI 7.6) due to the equilibrium reaction under the catalysis of strong base.

TABLE 2

| Examples | 8(C) | 9 | 10 | 11 | 12 | 13 |
|---|---|---|---|---|---|---|
| Polymers, % | I, 93.5 g | II, 93.5 g | III, 93.5 g | IV, 93.5 g | V, 93.5 g | VI, 93.5 g |
| Fumed silica, % | 6 | 6 | 6 | 6 | 6 | 6 |
| DBDL, % | 0.5 | 0.5 | 0.5 | 0.5 | 0.5 | 0.5 |

Before oil aging

| | | | | | | |
|---|---|---|---|---|---|---|
| Skin over time, hr | 2 | 1.5 | 3 | 1.5 | 1.5 | 3 |
| Hardness, Shore ◯◯ | 60 | 67 | 58 | 64 | 66 | 54 |
| Elongation, % | 310 | 330 | 410 | 290 | 263 | 360 |
| Tensile, psi (10\hat{ }−2) | 1500 | 1240 | 730 | 1110 | 1518 | 880 |

After oil aging in SF-015F engine oil @ 150° C.

| | | | | | | |
|---|---|---|---|---|---|---|
| Weight gain, % | Degraded | 75 | Degraded | Degraded | 40 | 54 |
| Elongation, % | before | 309 | after | after | 270 | 290 |
| Tensile, psi (10\hat{ }−2) | 500 hr | 2508 | 1000 hr | 1000 hr | 1291 | 820 |

Table 2 showed formulated compositions of silicone polymers and their properties. The compositions were tested with respect to skin-over time; and hardness, tensile strength and elongation after fully cured. The Examples were further tested after aging in SF-105 engine oil at 150° C. The Examples were examined once a week for 6 weeks or 1000 hr to determine whether they degraded, that is, loss of the integrity and shape of specimens, or dissolved partially or completely in the engine oil. If only after surviving 1000 hours, the 1000 hour survived Examples were weighed to determine weight gain in percent and post aging elongation and tensile properties.

All formulations have skin over time over less than 3 hr. After 48 hours, the fully cured compositions showed harness Shore OO >50. However, Example 8(C) degraded in the engine oil at 150° C. before 500 hr, and Examples 10 to 11 were degraded after 1000 hr, and could not be further tested. Only Example 9, 12 and 13 gave good results.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1: A silicone polymer having a structure of: 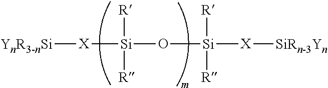
wherein,
each R, R′ and R″ are independently, alkyl, aryl, fluoroalkyl, trialkylsilyl, triarylsilyl, vinyl, H or combination thereof;
X is a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof;
Y is aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
m≥1;
n=1, 2, or 3;
the weight average molecular weight (Mw) of the silicone polymer is from 100 to 1,000,000 g/mol.

2: The silicone polymer of claim 1, wherein
each R, R′ and R″ are independently, methyl, phenyl, trifluoropropyl, vinyl, H, or combination thereof;
X is a linear linkage having a divalent alkylene, siloxane-alkylene, siloxane-arylene, or a derivative or combination thereof;
Y is oximino, enoxy, α-hydroxycarboxylic acid amide (—OCR′₂CONR″₂), α-hydroxycarboxylic acid ester (—OCR′₂COOR″), or combination thereof;
n=2 or 3.

3: The silicone polymer of claim 1, having a structure of:

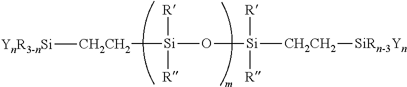

4: The silicone polymer of claim 1, having a structure of: 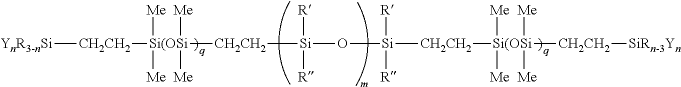
wherein, q≥1.

5: The silicone polymer of claim 4, having a structure of:

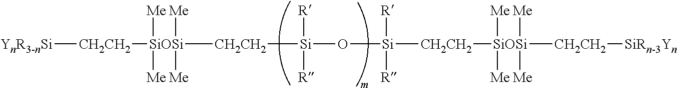

6: A method of making the silicone polymer of claim 1 comprising a reaction product of:
(i) about 10 to about 90% of a vinyl terminated polyorganosiloxane having a weight average molecular weight greater than about 100,000 g/mol;
(ii) about 1 to about 50% of a vinyl terminated polyorganosiloxane having a weight average molecular weight less than about 100,000 g/mol;
(iii) about 0.1 to about 10% of a hydride functional silane YₙR₃₋ₙSiH; and
(iv) about 0.00001 to about 5% of a hydrosilylation catalyst.

7: A method of making the silicone polymer of claim 4 comprising a reaction product of:
(i) a first reaction product of:
(a) about 50 to about 90% of a vinyl terminated polyorganosiloxane having a weight average molecular weight greater than about 100,000 g/mol;
(b) about 1 to about 50% of a vinyl terminated polyorganosiloxane having a weight average molecular weight less than about 100,000 g/mol;
(c) about 1 to about 50% of hydride terminated polyorganosiloxane a having a weight average molecular weight less than about 100,000 g/mol; and
(d) about 0.00001 to about 5% of a hydrosilylation catalyst;
(ii) about 0.1 to about 10% of a vinyl functional silane YₙR₃₋ₙSi(CH═CH2); and
(iii) about 0.00001 to about 5% of a hydrosilylation catalyst.

8: A moisture cure composition comprising a silicone polymer having a structure of: 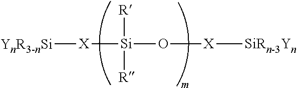
wherein,
each R, R′ and R″ are independently, alkyl, aryl, fluoroalkyl, trialkylsilyl, triarylsilyl, vinyl, H or combination thereof;
X is a linear, cyclic, or branched link having a divalent alkylene, arylene, oxyalkylene, oxyarylene, siloxane-alkylene, siloxane-arylene, ester, amine, glycol, imide, amide, alcohol, carbonate, urethane, urea, sulfide, ether, or a derivative or combination thereof;
Y is aryloxy, acetoxy, oximino, enoxy, amino, α-hydroxycarboxylic acid amide (—OCR′₂CONR″₂), α-hydroxycarboxylic acid ester (—OCR′₂COOR″), H, halogen, or combination thereof;
m≥1;
n=1, 2, or 3;
the weight average molecular weight (Mw) of the silicone polymer is from 100 to 1,000,000 g/mol.

9. The moisture cure composition of claim 8,
wherein the silicone polymer has a structure of:

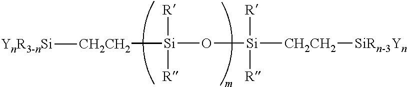

10. The moisture cure composition of claim 8, wherein the silicone polymer has a structure of:

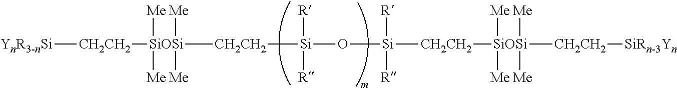

11: A moisture curable composition comprising:
(i) about 10 to about 90% of the silicone polymer of claim 8,
(ii) about 5 to about 90% of a finely-divided inorganic filler or a mixer of fillers,
(iii) about 0.00001 to about 5% of a moisture curing catalyst.

12: The moisture curable composition of claim 11, wherein said filler is selected from the group consisting of fumed silica, clay, metal salts of carbonates, sulfates, phosphates, carbon black, metal oxides, quartz, zirconium silicate, gypsum, silicon nitride, boron nitride, zeolite, glass, and combinations thereof.

13: The moisture curable composition of claim 12, wherein said filler is selected from the group consisting of a combination of fumed silica, calcium carbonates and magnesium oxide.

14: The moisture curable composition of claim 11, wherein said filler selected from the group consisting of silicone resins, organic fillers, plastic powder, and combinations thereof.

15: The moisture curable composition of claim 11, wherein said moisture curing catalyst selected from the group consisting of: organic titanium compounds, organic tin compounds, organic amines, and combinations thereof.

16: The moisture curable composition of claim 11, further comprising a reactive silane.

17: The moisture curable composition of claim 16, wherein said reactive silane is selected from the group consisting of alkoxy silanes, acetoxy silanes, enoxy silanes, oximino silanes, amino silanes, lactate ester silanes, lactate amido silanes and combinations thereof.

18: The moisture curable composition of claim 17, wherein said reactive silane comprises vinyltrioximinosilane, vinyltrialkoxysilane, and combinations thereof.

19: The moisture curable composition of claim 11, further comprising an adhesion promoter.

20: The composition of claim 19, wherein said adhesion promoter is selected from the group consisting of tris(3-(trimethoxysilyl) propyl) isocyanurate, γ-ureidopropyltrimethoxy silane, γ-aminopropyltrimethoxy silane, and combinations thereof.
